(19) United States
(12) Patent Application Publication
(10) Pub. No.: US 2026/0238662 A1
(43) Pub. Date: Aug. 13, 2026

(54) METHOD FOR TRAINING AND USING A NETWORK INTRUSION DETECTION SYSTEM (NIDS)

(71) Applicant: TELEFONAKTIEBOLAGET LM ERICSSON (PUBL), Stockholm (SE)

(72) Inventors: Zhongwen ZHU, Saint-Laurent (CA); Kin-Choong YOW, Regina (CA); Ho CHI, Calgary (CA); Sarang ARAVAMUTHAN, Santa Clara, CA (US)

(73) Assignee: TELEFONAKTIEBOLAGET LM ERICSSON (PUBL), Stockholm (SE)

(21) Appl. No.: 19/156,733

(22) PCT Filed: Mar. 2, 2023
(86) PCT No.: PCT/IB2023/051961

§ 371 Date: Aug. 14, 2025

(51) Int. Cl. H04L 9/40; H04L 41/16

(52) U.S. Cl. CPC H04L 63/1425; H04L 41/16

(57) ABSTRACT

A method, for training a machine learning (ML) model and for using the ML model for detecting an intrusion in a network is provided. The detection method comprises obtaining a window size, an overlapping window size and a plurality of data flows from the network, each data flow comprising a measurement for a plurality of features of the data flow. The method comprises extracting a flow pattern from the data flows, based on the window size and the overlapping window size, the flow pattern comprising data flows that are comprised within a sliding window of window size, the sliding window being moved by (window size—overlapping window size) at each iteration. The method comprises converting the flow pattern into an image, inputting the image into the ML model for obtaining a label indicating a type of network intrusion detection, and refining the overlapping window size based on the label.

### TECHNICAL FIELD

The present disclosure relates to adaptive network traffic sampling for image-based network traffic detection and classification using feedback from network attack prediction.

### BACKGROUND

Over the last five years, the cost of cybercrime has increased by 67%. More than sixteen essential industry groups became prime targets of cyber-attacks with large losses. In recent years, along with the continuous development of new network technologies, more sophisticated and dangerous new types of cyberattacks are emerging. Malwares can attack via many different platforms, and they can hide themselves in the networks for a long time without being detected.

Therefore, ensuring network security over the network layers becomes extremely important. To mitigate these attacks, Intrusion Detection Systems (IDSs) are used to continuously monitor the networks and to classify or predict potential malicious actions.

There are many different types of IDSs and currently, the signature detection based IDSs, and anomaly detection based IDSs are the most popular and most effective in network security. Research on signature based IDSs and anomaly detection based IDSs started a long time ago but is still an active area because of the diversity of components that create the IDSs such as the model, the research method, and the framework. Besides, there is also no consensus on the evaluation and validation methods of IDSs as researchers use many diverse approaches such as experiments, simulations, or both to evaluate their models. The method of using evaluation metrics on the test datasets is still the most popular and the most widely used today.

### SUMMARY

The solution proposed herein can be used to improve both signature detection based IDSs, and anomaly detection based IDSs.

There is provided a computer implemented method, for training a network intrusion detection system (NIDS) for detecting an intrusion in a network. The method comprises obtaining a plurality of data flows from the network and corresponding labels, each data flow of the plurality of data flows comprising a measurement for each of a plurality of features of the data flow. The method comprises defining a window size and a plurality of overlapping window sizes. The method comprises extracting flow patterns from the data flows, based on the window size and the plurality of overlapping window sizes, each flow pattern comprising data flows that are comprised within a sliding window of window size, the sliding window being moved by (window size—overlapping window size) data flows for extracting a next flow pattern. The method comprises converting the flow patterns into images. The method comprises inputting the images, and flow labels into a machine learning (ML) model for training the ML model for network intrusion detection.

There is provided a computer implemented method, for detecting an intrusion in a network, using a network intrusion detection system (NIDS). The method comprises obtaining a window size and an initial overlapping window size. The following steps are executed iteratively. The method comprises obtaining a plurality of data flows from the network, each data flow of the plurality of data flows comprising a measurement for each of a plurality of features of the data flow. The method comprises extracting a flow pattern from the data flows, based on the window size and the overlapping window size, the flow pattern comprising data flows that are comprised within a sliding window of window size, the sliding window being moved by (window size—overlapping window size) at each iteration. The method comprises converting the flow pattern into an image. The method comprises inputting the image, into a trained machine learning (ML) model for obtaining a label indicative of a type of network intrusion detection. The method comprises refining the overlapping window size based on the obtained label.

There is provided a network intrusion detection system (NIDS) comprising processing circuitry and a memory. The memory contains instructions executable by the processing circuitry whereby the NIDS is operative to obtain a plurality of data flows from the network and corresponding labels, each data flow of the plurality of data flows comprising a measurement for each of a plurality of features of the data flow. The NIDS is operative to define a window size and a plurality of overlapping window sizes. The NIDS is operative to extract flow patterns from the data flows, based on the window size and the plurality of overlapping window sizes, each flow pattern comprising data flows that are comprised within a sliding window of window size, the sliding window being moved by (window size—overlapping window size) data flows for extracting a next flow pattern. The NIDS is operative to convert the flow patterns into images. The NIDS is operative to input the images, and flow labels into a machine learning (ML) model for training the ML model for network intrusion detection.

There is provided a network intrusion detection system (NIDS) comprising processing circuitry and a memory. The memory contains instructions executable by the processing circuitry whereby the NIDS is operative to obtain a window size and an initial overlapping window size. The NIDS is operative to execute the following operations iteratively. The NIDS is operative to obtain a plurality of data flows from the network, each data flow of the plurality of data flows comprising a measurement for each of a plurality of features of the data flow. The NIDS is operative to extract a flow pattern from the data flows, based on the window size and the overlapping window size, the flow pattern comprising data flows that are comprised within a sliding window of window size, the sliding window being moved by (window size-overlapping window size) at each iteration. The NIDS is operative to convert the flow pattern into an image. The NIDS is operative to input the image, into a trained machine learning (ML) model for obtaining a label indicative of a type of network intrusion detection. The NIDS is operative to refine the overlapping window size based on the obtained label

There is provided a non-transitory computer readable media having stored thereon instructions for executing a method in a network intrusion detection system (NIDS), the instructions comprising any of the steps described herein.

The methods and system provided herein present improvements to the way network intrusion detection systems (NIDSs) operate.

### BRIEF DESCRIPTION OF THE DRAWINGS

FIG. 1 is a block diagram of an anomaly detection system.

FIG. 2 is a block diagram of an improved flow to image converter.

FIG. 3 is an example data flow illustrating windows without overlap.

FIG. 4 is an example data flow illustrating windows with an overlap.

FIG. 5 is an example data flow illustrating windows with a sampling interval.

FIG. 6 is a flowchart of a method for determining an overlapping window size.

FIG. 7 is an example data flow illustrating windows with an overlap.

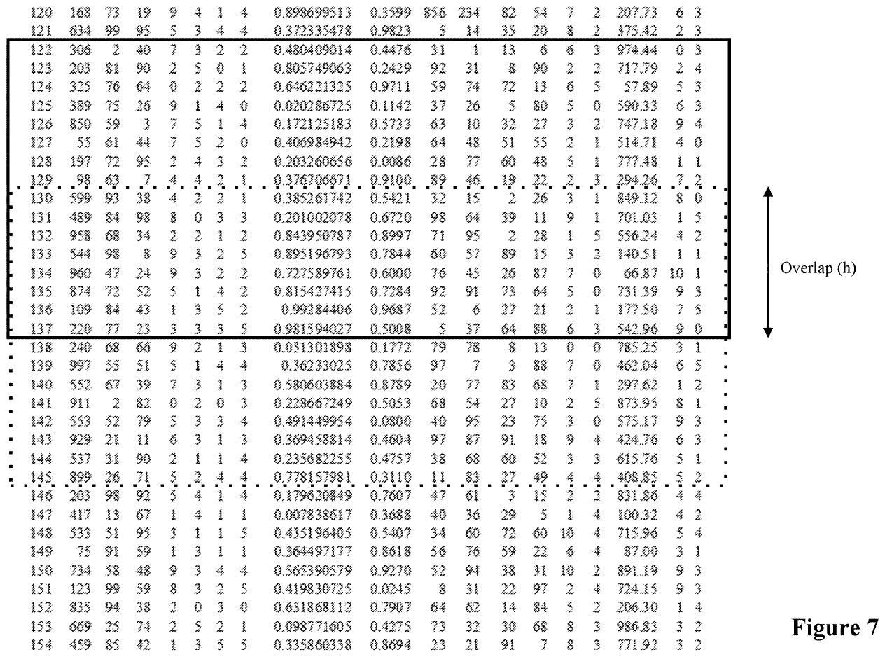

FIG. 8 is a graph illustrating processing time according to the size of the overlapping windows for different types of attacks.

FIG. 9 is a graph illustrating the model accuracy according to the size of the overlapping windows for different types of attacks.

FIG. 10 is a schematic illustration of a confusion matrix of the solution without the improvement, in inference mode.

FIG. 11 is a schematic illustration of a confusion matrix of the improved solution with a model using feedback from network attack prediction, in inference mode.

FIG. 12 is a flowchart of a method for training a network intrusion detection system (NIDS) for detecting an intrusion in a network.

FIG. 13 is a flowchart of a method for detecting an intrusion in a network, using a network intrusion detection system (NIDS).

FIG. 14 is a schematic illustration of a hardware in which steps and/or method described herein can be executed.

FIG. 15 is a schematic illustration of a virtualization environment in which the different steps and hardware components described herein can be deployed.

### DETAILED DESCRIPTION

Various features will now be described with reference to the drawings to fully convey the scope of the disclosure to those skilled in the art.

Sequences of actions or functions may be used within this disclosure. It should be recognized that some functions or actions, in some contexts, could be performed by specialized circuits, by program instructions being executed by one or more processors, or by a combination of both.

Further, computer readable carrier or carrier wave may contain an appropriate set of computer instructions that would cause a processor to carry out the techniques described herein.

The functions/actions described herein may occur out of the order noted in the sequence of actions or simultaneously. Furthermore, in some illustrations, some blocks, functions, or actions may be optional and may or may not be executed; these are generally illustrated with dashed lines.

At least some aspects of the techniques described herein may be implemented using artificial intelligence, which comprises a variety of techniques as would be apparent to a person skilled in the art, including machine learning techniques. Machine learning techniques include Neural Network (NN), or Artificial Neural Network (ANN), and both terms may be used interchangeably herein. In some contexts, an Artificial Neural Network could include biological portions.

One of the main challenges of Network IDSs (NIDSs) is the massive data size of the network flows that needs to be handled. For each flow, there are many possible features (e.g., inter-arrival time, packet size, etc.) that can be extracted, but not every feature is useful in determining whether an attack is underway or not. Another challenge is the variety of network intrusions and the ambiguity of each type of intrusion. There are many different types of attacks and some of them share similar features, leading to misclassifications. A third challenge is that there are always new types of attacks that have not being seen before by the NIDS, and thus the NIDS is not able to recognize that an attack is in progress.

To improve the performance and accuracy of NIDS, a method that converts a network flow pattern, within a specific time interval, into a two-dimensional image is proposed. One dimension of the image is the various measurements of the network flow (aka features), and the other dimension represents the values of these measurements over time. Image processing techniques are then used to classify these images as malicious or benign. This approach allows all, or a majority of, the available information (i.e., other measurements or features that may not be directly related to the attacks) to be used in the classification, to reduce false positives.

In addition, some of the advances in image classification techniques can also help to improve processing speeds. For example, if convolutional neural networks (CNNs) are used, the size of the mask and the stride of the convolution can be adjusted to achieve better computational efficiency. Similarly, using the multi-head attention mechanisms in Vision Transformer (ViT), the computational efforts can be focused in regions of interest.

In 2022, a new method of network intrusion detection was published by the inventors (Chi M. K. H., Kin C. Y., Zhongwen Zhu., Sarang A., “Network intrusion detection via flow-to-image conversion and visual transformer classification”, IEEE Access Journal, 2022 August) to increase the performance of Network Intrusion Detection Systems (NIDSs).

In the method, intrusion detection is performed by converting input network flows into a red, green, blue (RGB) image, and then a Vision Transformer (ViT) technique is applied to classify the image. To decide what network flow features are important for the classification, a decision tree algorithm is used to compute the importance of each feature.

Herein, a window and overlapping mechanism is added to improve the method of network intrusion detection described in in the previously cited paper, which is included herein by reference in its entirety.

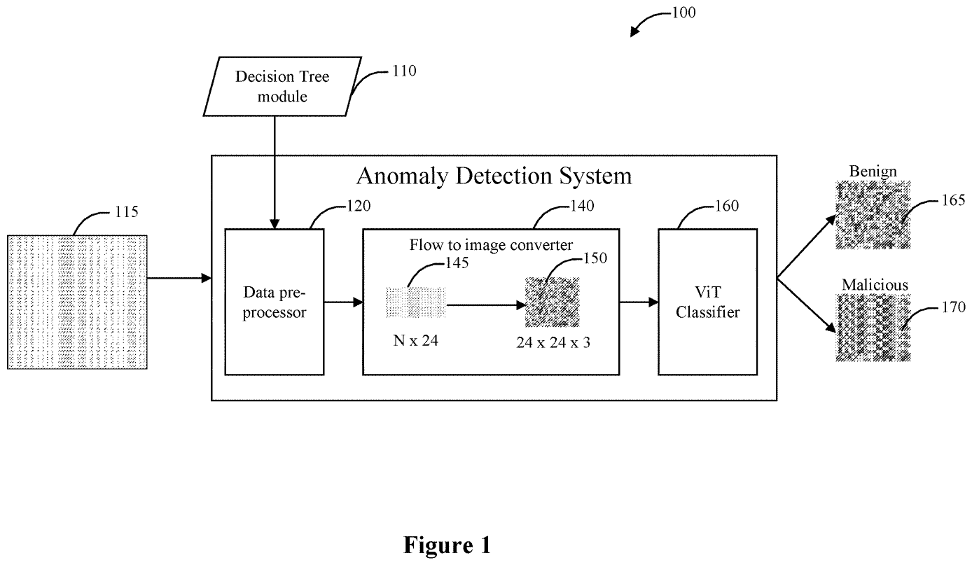

FIG. 1 illustrates the architecture of the system 100, which consists of three main modules: a data pre-processing module 120, a flow to image converter module 140 and a classifier module 160. During the training phase of the system, a decision tree classification process is applied, via a decision tree module 110, to the training data to find the importance of all the features so that the most important features to be used in the conversion of the data flow 115 to an image can be chosen. During normal execution, the data first goes through the data pre-processing module 120, where the important features that were found during the training phase are extracted. The pre-processed output 145 then goes through the flow to the image converter module 140 and is converted to a series of RGB images 150. These images 150 are then sent to the classifier module 160 and are classified by a deep learning classifier into two categories depending on if it contains benign 165 or malicious 170 flows.

The data pre-processor module 120 (after important features are identified) is now explained.

Before the data pre-processor module can be used for intrusion detection, the important features to extract from, for example, a coma separated values (CSV) file need to be identified. Each row of the CSV file represents one network flow, and each column represents a particular network feature. For example, in the CIC IDS2017 dataset, there are seventy-eight features and hence the CSV file has seventy-eight columns. To determine which features are important in identifying the attacks, the decision tree classification algorithm is applied to choose the most important features for each type of attack. The Mahalanobis Distance-based Oversampling (MDO) technique is used to balance the distance of each class to increase the accuracy of the decision tree. MDO is an oversampling technique using the Mahalanobis distance to generate synthetic samples. This method is proven to be effective in multi class and multi-label classification models using imbalance datasets for training.

The description is mostly based on an example, with specific dataset and features. A person skilled in the art would understand that this example is used for rendering the subject matter easier to understand. Many alternatives are also possible, and it is the intent of the inventors to include all the possible variations herein. In the example, the CIC IDS2017 dataset is used, in which there are eight different classes of network flow data (seven malicious and one benign). They are the Patator, Benign, DDoS, DoS, Bot, PortScan, Heartbleed, Infiltration. A decision tree is built for combining all types of attack with benign requests. The information gain (IG) of twenty-four features which have the highest value is used for selection. By selecting features that have an IG value of at least 0.001 in at least one type of attack, twenty-four features were obtained that will be used in the NIDS presented herein. These features include, for example: (1) internet protocol (IP) number of source machine, (2) average size observed in the forward direction, (3) average number of bytes in a subflow in the forward direction, (4) port number of destination machine, (5) average size of packet, (6) port number of source machine, (7) minimum size of packet in backward direction, (8) minimum time a flow was idle before becoming inactive, (9) average size of packet in forward direction, (10) count number of push (PSH) flag, (11) flow duration, (12) a total number of bytes used for headers in the forward direction, (13) maximum time between two packets sent in the forward direction, (14) standard deviation time between two packets sent in the forward direction, (15) maximum time a flow was idle before becoming active, (16) number of bytes sent in the initial backward window, (17) minimum segment size observed in the forward direction, (18) minimum time between two packets sent in the forward direction, (19) mean time a flow was active before becoming idle, (20) maximum time a flow was active before becoming idle, (21) number of packets with at least one byte of transmission control protocol (TCP) data payload in the forward direction, (22) mean size of packet in backward direction, (23) number of forward packets per second, and (24) mean length of a flow. The source IP is also encoded to facilitate the conversion to image format.

During the execution of the intrusion detection process, the data pre-processor module read the input from a CSV file, where the rows of the CSV file represent the network flows, and the columns represent the features.

First, the number of rows in the CSV files are reviewed and there is a check to confirm if there are enough rows to generate a square image (this is because the final module (i.e., the classifier module) in the intrusion detection process of the example used herein requires a square image). A person skilled in the art would readily understand that formats, other than a 24×24 square image, such as rectangle images of different sizes, could be used in other example embodiments. In the present example, twenty-four important features were identified for attacks of interest (i.e., the CSV file contains twenty-four columns). The input CSV file should have at least twenty-four rows. If not, new empty rows with 0 values for all features can be added to the CSV file. Next, all columns in the CSV file other than the twenty-four columns identified as being important features for the intrusion detection system are removed. This new CSV file becomes the input to the next module, the flow to image converter module 140, which is now explained.

The pre-processed CSV files are of different sizes (the number of columns corresponds to the number of important features i.e., twenty-four, in the current example, but the number of rows is tied to time stamps that correspond to when measures for those features were made. Therefore, additional processing is needed to ensure that the images have right sizes that are suitable for the modules in the proposed solution. This is achieved in two steps: (i) mapping the flow data to RGB values, and (ii) windowing and overlapping mechanism.

### i) Mapping Flow Data to RGB Values.

In this step, a blank image that has the same height and width as the number of rows and columns of the new CSV file is initialized. After that, each feature value from the new CSV file will be converted to an RGB value in the range of 0000000 to 0xFFFFFF (i.e., 24-bit color). This is achieved by finding the highest and lowest value of each feature in the dataset, and then use this feature range to map the feature value linearly to the 24-bit RGB range. In decimal, this 24-bit range is from 0 to 16777215 (i.e., 16.7 million colors). The algorithm of this mapping is shown in Algorithm 1 below.

Algorithm 1 The Algorithm of Mapping Flow Data to RGB Values

| | |
|---|---|
| 1: | Input Nx24 csv file |
| 2: | RGB_image = (N, 24, 3) |
| 3: | col = 1 |
| 4: | row = 1 |
| 5: | while col <= 24 do |
| 6: | while row <= N do |
| 7: | RGB_feature_value = (Color_range/(feature_Max-feature_Min)) feature_Value |
| 8: | Pixel_color = (int(conversion_value/256)%256), (conversion_value%256), |

(RGB_feature_value%256))

| | |
|---|---|
| 9: | RGB_image[col][row] = Pixel_color |
| 10: | row = row + 1 |
| 11: | end while |
| 12: | col = col + 1 |
| 13: | end while |
| 14: | Output image |

Some of the parameters used in the algorithm 1 are as follows:
RGB_image: is the initial (N×24×3) image;
RGB_feature_value: is the value of feature which is represented in the range of RGB color (0 to 0xFFFFFF);
Color_range: is equal to 0xFFFFFF in decimal;
row: is the value of the height of the CSV file following timeframe, herein it is N;
cols: is the value of the width of the CSV file following timeframe, herein it is defined by 24;
feature_Max: is the maximum value of a feature in the input CSV file;
feature_Min: is the minimum value of a feature in the input CSV file;
feature_Value: is the value of a feature in input CSV file;
Pixel color: is the RGB value of one pixel which is represented as (RR, GG, BB); and
conversion_value: is a value calculated by RGB_feature_value divided by 256 (0xFF) converted to an integer.

Every 8 bits (i.e., 2 digits in hexadecimal) of the 24-bit RGB value is the value of each color component. The first 8 bits (the first two digits in hexadecimal) is the value of the red component. The next 8 bits is the value of the green component, and the last 8 bits is the value of the blue component. By taking the modulo division of the 24-bit value by 0xFF (i.e., 256 in decimal) twice, it is possible to get the values of the individual red, green, and blue color components. These color components are then added into the corresponding location in the RGB image. This process is then repeated for all the selected features that are measured within a targeted time-period, which was reported in the CSV file.

The training labels for each N×24×3 image are based on whether an attack flow exists during the timeframe represented by the rows of the image. If an attack exists, the type of the attack will be taken as the training label for this image.

### ii) Windowing and Overlapping Mechanism.

The image that is generated is an N×24×3 image, where N is the number of rows in the CSV file, twenty-four is the number of features that were selected from the decision tree algorithm, and three is the number of channels (red, green, blue). As N may be different in every CSV file, in the example presented herein, the image is reshaped from N×24×3 to a square 24×24×3 image. This makes the design of the classier module easier as the dimensions are fixed.

A windowing and overlapping mechanism is used to reshape the images of the flows, previously generated, which had a number N of rows, into squares.

In one example, the raw dataset from CSV file is sliced into seven different 24×24×3 images with an overlapping size of twelve rows (i.e., half of the square 24×24×3 image). The first square image is extracted from the first row of the initial image (i.e., position height_0=0 and width_0=0) to the last row of the square output image (i.e., position height_0=24 and width_0=24). The second image is cropped from the halfway point of the first image (i.e., position height_1=height_0+12 and width_1=0) to a position twenty-four rows below that (i.e., position height_1=height_0+12+24 and width_1=24). This action is repeated until the row number exceeds the height of initial image. Then the final square image is cropped from the last position of the initial image (i.e., position height_n=78-24 and width_n=0) to the end of the initial image (i.e., position height_n=78 and width_n=24). The algorithm for the windowing and overlapping mechanism is shown in Algorithm 2 below.

Algorithm 2 The Algorithm of the Windowing and Overlapping Mechanism

| | |
|---|---|
| 1: | Input image |
| 2: | rows, cols = image_size |
| 3: | if (h + 24) <= (rows − 1) then |
| 4: | output_image = cropfrom(0, h) to (cols, h + expected_output_height) |
| 5: | else |
| 6: | output_image = cropfrom(0, rows-expected_output_height) to (cols, rows) |
| 7: | end if |
| 8: | h = h + overlappingSize |
| 9: | Export square image |
| 10: | if (h > rows) then |
| 11: | Go to step 3 |
| 12: | end if |

Some of the parameters used in the algorithm 2 are as follows:
image_size: includes the number of columns and rows of the network flow which need to be converted to an image (N×24);
row: is the value of the height of the initial image (N×24×3), herein it is defined as N;
cols: is the value of the width of the initial image (N×24×3), herein it is defined by 24;
H: is the shifting value which is used for overlapping the images; and
expected_output_height is the height of the output image, herein the output image is a square so the expected_output_height is equal cols (=24).

The classifier module 160 is now explained.

This module is the classifier that classifies the 24×24×3 image into one of the output classes. The ViT is used as the classifier. However, the more commonly used convolutional neural network (CNN) or other classifiers could be used alternatively.

The ViT transformer model was first introduced by Ashish et al. in 2017. By using self-attention layers to capture long-term dependencies, the transformer can learn more diverse interactions between spatial locations and processes input asynchronously, which helps the model to become faster. After announcing the transformer's outstanding results in the field of natural language processing (NLP), ViT has also been proposed and applied in different contexts related to NIDS. ViT has been shown to compare somewhat better than convolutional models.

The architecture of ViT includes a Transformer encoder with a Multilayer Perceptron (MLP) head for the classification and linear projection of flattened patches in the image, to embed their positions in each part of the image. The input image is split into fixed-size patches, and each patch is linearly embedded, slotted, and then transformed into tuples (i.e., resulting vector sequences) which are then fed to a standard Transformer Encoder. A learnable “classification token” is then added to the string, and then given to the classifier to classify the images. In the ImageNet Real input dataset, the ViT model produces the highest result of 90.72%, compared to 90.55% for EfficientNet L2. The ViT is trained in the same way as the linear ViT model of A. Dosovitskiy et al. (A. Vaswani, N. Shazeer, N. Parmar, J. Uszkoreit, L. Jones, A. Gomez, L. Kaiser, and I. Polosukhin, “Attention is all you need,” in Proc. Adv. Neural Inf. Process. Syst., 2017, pp. 5998-6008).

The ViT is, for example, first pre-trained with the data of ImageNet-21K, and then fine-tuned by stochastic gradient descent (SGD) with a momentum of 0.9. The ViT model is trained using the AdamW optimizer with a learning rate of 2e-5.

Once the model is trained, it can be used for binary classification based on two labels: benign and malicious.

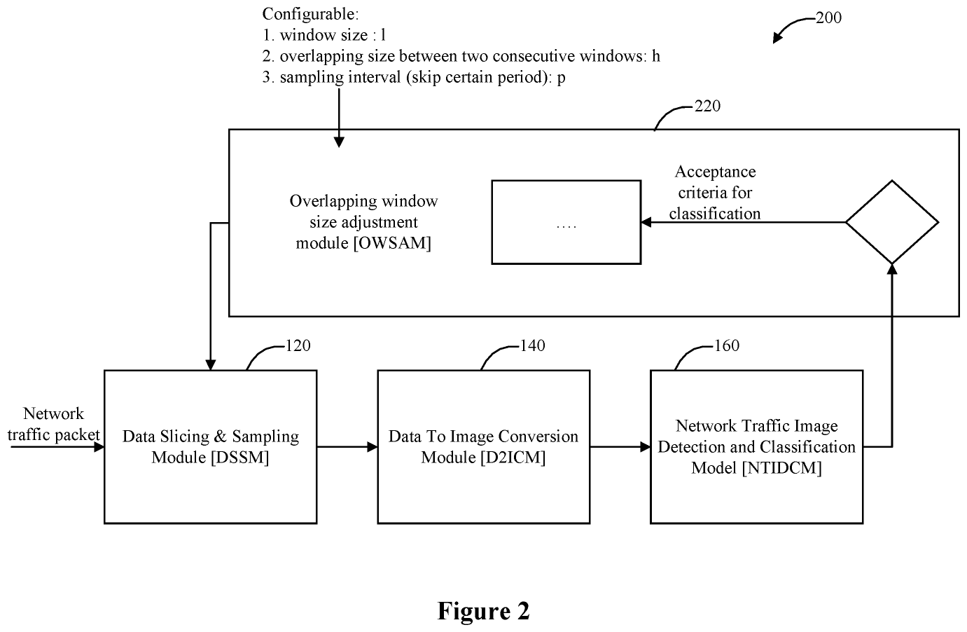

An improvement 200 to the previously described system is proposed hereinbelow and is illustrated in FIG. 2.

A new image window can be applied to cut the network flow image, which is converted, before following a specific time interval, to many images, which are square images in the example used herein. After that, the image overlapping mechanism can be used to repeat part of the previous image inside the next adjacent image to increase the performance of the system by maintaining the continuity of the network flow. Based on the size of the square image, which is set to 24×24 herein, as an example, the overlapping size can be changed from 1 to 24 with 24 as non-overlapping and 1 as overlapping 23 rows out of 24. Previously, overlapping was fixed to size 12, repeating half of the image.

Experimental results have shown that the method described previously outperforms other state-of-the-art algorithms. For the binary classification problem, the method achieves an accuracy of 98.5% on the CIC IDS2017 dataset and 96.3% on the UNSW-NB15 dataset.

For the multi-class classification problem, the proposed method also outperformed the other state-of-the-art methods. It has an accuracy of 96.4%

New technologies such as fifth generation (5G) networks are demanding systems with increasingly higher accuracy and faster processing speed. With this in mind, the solution described above is modified to be qualified for use in real networks, such as 5G networks.

The rapid development of 5G networks impacts on every aspect of our daily life. 5G networks optimize performance, latency, and speed and provide bi-directional large bandwidth shaping. However, some of the main elements that affect the optimization potential of 5G networks are the stability and the security. Due to the fast speed of 5G networks, there is a need for a security analysis system that is fast and accurate enough to identify potential attacks.

To capture accurate network traffic behavior, a mechanism that allows variable overlap to occur between two consecutive images through a given window size is introduced to the method discussed above.

The smaller the overlapping window size, the lower the accuracy of the detection from the image-based detection model.

When the overlapping window size increases, the accuracy of the detection increases. The cost for getting better accuracy is the usage of computer resources.

If the overlapping window size is increased a lot, the accuracy of the detection might decrease due to the overfit of the data points.

Although improvement of model accuracy can be achieved by increasing the overlapping window size, this comes at the expense of extra usage of computational resources for data processing and storage. The changes of the overlapping window size leads to changes in the amount of data to be generated as well as the amount of computer resources required for processing the data.

How to manage the overlap window size to balance the trade-off between the accurate prediction and the usage of computer resources in a live network is a big challenge that is addressed herein.

One goal is to control the overlapping window size based on feedback from the traffic prediction in the network, which covers four major scenarios:
normal traffic;
abnormal traffic with known attacks;
abnormal traffic with known attacks that need to be further clarified; and
abnormal traffic with unknown attacks.

Through the overlapping window adjustment mechanism, the proposed solution can control the data to be generated for the artificial intelligence (AI)/machine learning (ML) model (for the classifier module). The solution reduces the footprint of the intelligence built in the network for anomaly detection and classification.

The solution described hereinbelow provides flexible mechanisms that will contribute to making intrusion detection more accurate and more specific to each type of attack, through which better performance can be achieved. The proposed solution utilizes computer resources more efficiently and leads to energy savings while still achieving accurate detection.

Referring to FIG. 2, there are four components in the proposed improved solution. The detailed description of each component is presented hereafter.

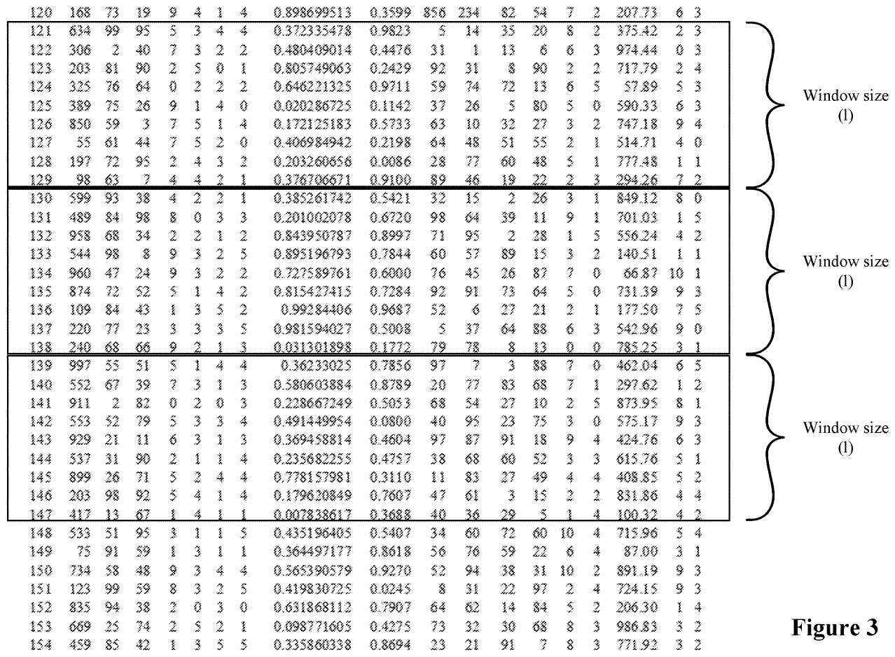

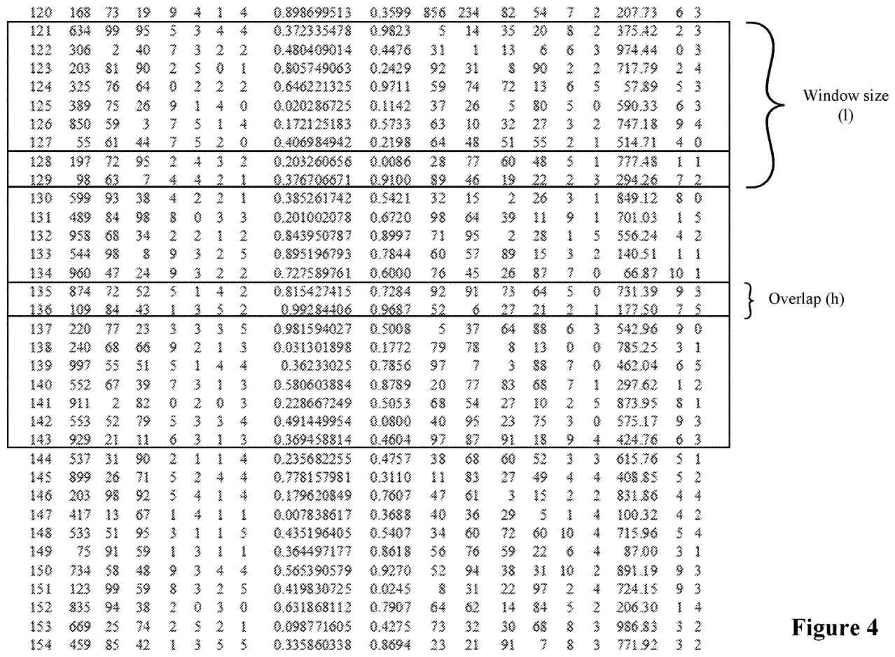

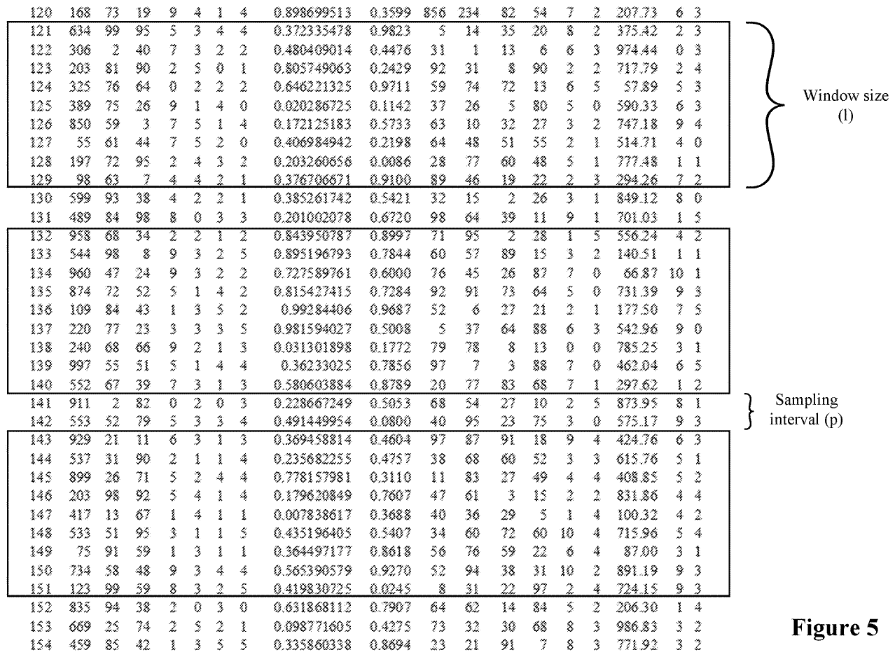

Data slicing & sampling module (DSSM) 120 (corresponding to the data pre-processor of FIG. 1): this module is responsible for slicing the dataset according to a given window size and managing the overlapping window size on the received network traffic packets. DSSM receives a configuration (window size, overlapping window size and/or sampling interval) from the OWSAM module (described further down) and apply it to generate a dataset to be processed by the D2ICM module (described next). FIGS. 3 to 5 are self-explanatory and illustrate window size, overlapping window size and sampling interval, respectively.

Data to image conversion module (D2ICM) 140 (corresponding to the flow to image converter of FIG. 1): this module is responsible for converting the dataset from the DSSM into an image. It is also responsible for repairing the dataset if damage or missing features are identified.

Network traffic image detection and classification module (NTIDCM) 160 (corresponding to the ViT Classifier of FIG. 1): this module is responsible for building a detection and classification model (training mode) as well as providing prediction on “network attacks” using the trained model (inference mode).

In training mode, an image-based classification model, e.g., a CNN, can be used. With labelled image, the model in the NTIDCM can be trained to detect different attacks using stochastic gradient descent. The model, once it converges to given criteria, is stored. If the model doesn't converge, the NTIDCM sends a request to the OWSAM to adjust the window size and overlapping window size so that the DSSM can provide more dataset for the NTIDCM to improve the model's accuracy.

In inference mode, the trained model is deployed in the network. The trained model does the prediction for the images given by the D2ICM. Then the NTIDCM sends the prediction to the OWSAM so that the OWSAM can decide what kind of configuration should be used to control the overlapping window size in the coming time-period.

Overlapping window size adjustment module (OWSAM) 220 (no correspondence in FIG. 1): this module is responsible for making a decision concerning the window size, the overlapping window size and/or the sampling interval based on the outcome of the prediction given by NTIDCM. If any changes are needed on the window size, the overlapping window size and/or the sampling interval, the OWSAM can push the new window size, the overlapping window size and/or the sampling interval to the DSSM or notify the DSSM to pull the new/updated configuration.

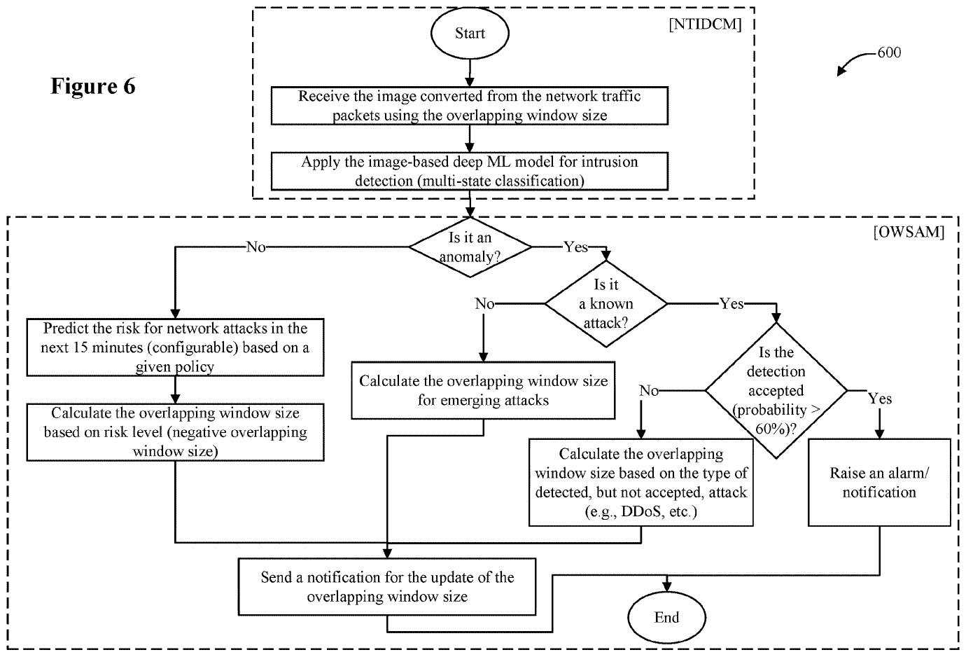

FIG. 6 illustrates the method 600 for computing the overlapping window size. The top part is implemented in NTIDCM 160, while the bottom part is implemented in the OWSAM 200.

The detailed logics for NTIDCM are as follows. In a first step, the NTIDCM received an image converted from the network traffic packets using the overlapping size window. Then the NTIDCM applies the image based deep ML model for intrusion detection which provides a multi-state classification. This multi-state classification is used as input for the OWSAM.

The detailed logics for OWSAM are as follows. If the network traffic is determined to be “Normal”, the OWSAM predicts the risk to have network attacks based on a given policy and the model, which was trained using an historical dataset. If the risk is low, the overlapping window size is set to zero and the sampling interval is increased, e.g., 1 min, 10 mins, 100 mins according to the predicted risk level.

If the network traffic is determined to be “Abnormal” and the OWSAM finds that the attack is unknown, the case is treated as an emerging attack. The OWSAM sends a notification or raises an alarm, then increase the overlapping window size, to monitor the network traffic more closely.

If the network traffic is determined to be “Abnormal” and the OWSAM finds that the attack is known but the detection outcome cannot be accepted according to the given policy/criteria, the OWSAM calculates the configuration of the window overlapping based on the type of the identified attack. It adjusts the overlapping window size in order to improve the detection accuracy of the next round.

If the network traffic is determined to be “Abnormal” with a probability above a set value, the OWSAM finds the type of attack and raises an alarm to inform the operator admin about this attack.

The detailed logics for the DSSM and the D2ICM were explained previously, in relation with Algorithm 2.

The solution was implemented for testing purposes. In the implementation, the D2ICM converts 24×24 CSV files to images, which are split by the data slicing/sampling module (DSSM).

In the example implementation, the NTIDCM classifies as benign or malicious the input images which were converted by the data to image conversion module (D2ICM).

After comparing performance between two types of classifiers, (CNN and ViT classifiers), the ViT classifier was selected as the ML model.

In the implementation of the OWSAM, some data processing is executed to identify anomalous requests and classify them more efficiently. The output result of the network traffic classification module is separated into three cases. Benign, known attack and unknow attack. Based on each case, the overlap size adjustment mechanism is applied to calculate the overlapping window size. Then a notification is sent to the DSSM, to update the overlapping window size for the next network flow.

Some test results are now discussed. The CIC IDS2017 dataset was used for testing the system. However, because of the imbalance of the dataset, minor types of attacks were grouped to the “unknown” class and that left four main types of attacks (distributed denial of service (DDoS), denial of service (DoS), Patator and HeartBleed). “Benign” was also used, and that led to having five different classes.

Experiments were conducted using the CIC IDS2017 dataset and the size of the overlapping window was changed from 1 to 24. From the results of the accuracy obtained from each size of overlapping window, an optimal range of overlapping sizes was obtained for each type of attack.

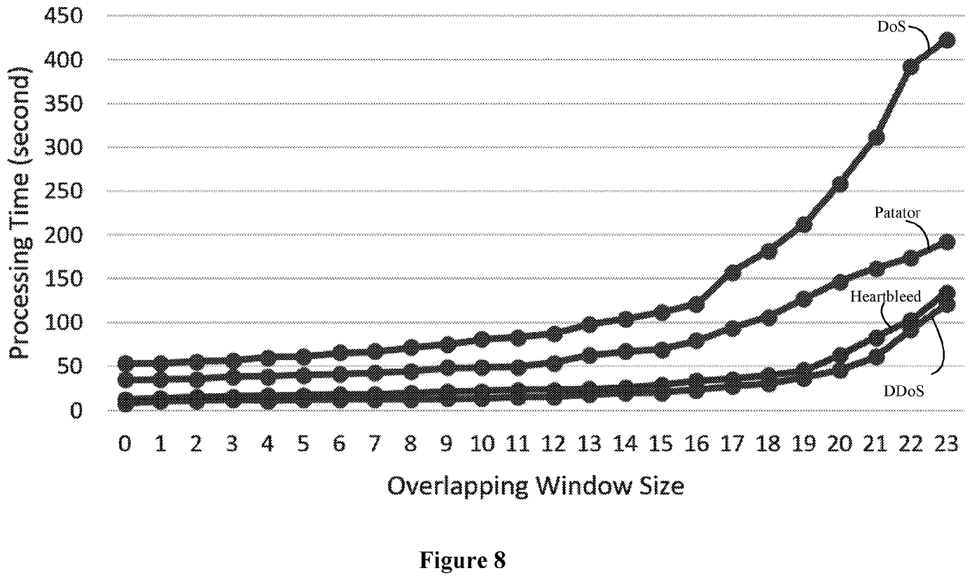

FIG. 8 shows the increase of processing time according to the size of the overlapping window for four types of attacks. It can be seen that larger sizes of overlapping window progressively increase the processing time.

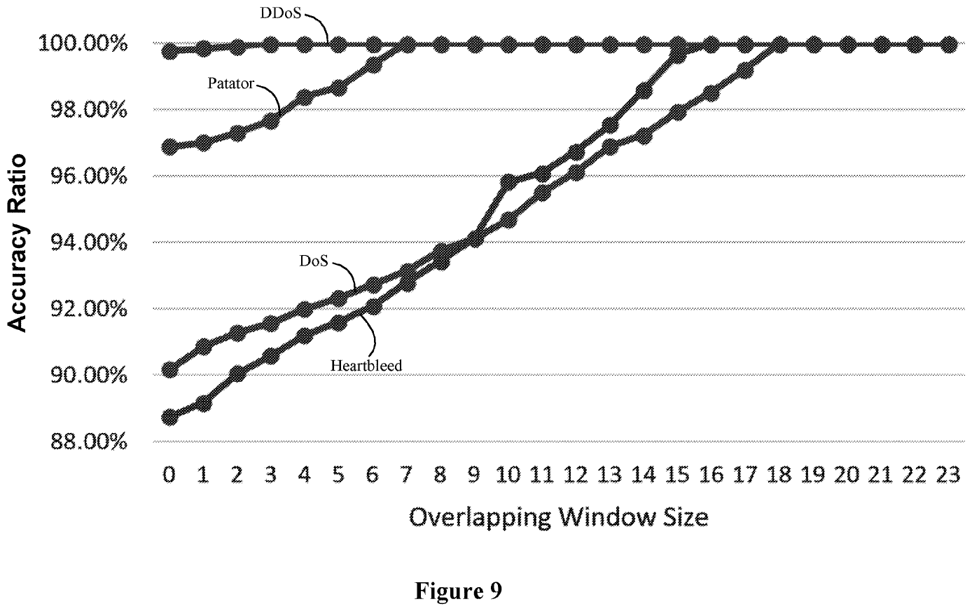

FIG. 9 shows the accuracy ratio for each size of overlapping. It can be seen that the larger the size of the overlapping window, the higher the achieved accuracy, for all types of attacks. Each type of attack achieves optimal accuracy at a certain overlapping window size and stay the same no matter how large the size continues to increase.

Based on the result shown in FIGS. 8 and 9 the overlapping size can be set to for the classes DDoS, DoS, Heartbleed and Patator as shown in table 1. For the benign class, for example, the overlapping window may be set to 5 and for the unknown type, the overlapping window size may be set to 23.

In general, for the benign class, the overlapping window size can alternatively be set under 5. If it is determined that there is low risk for network attacks, the overlapping window size can also be negative. In other word, certain time interval can be skipped. For instance, the time interval between two samplings could be set to a long period, e.g., 60 minutes if no security risk is predicted. Of course, when the risk is increased, this time interval can be reduced, and eventually the overlapping window replaces the time interval.

For unknown type, the overlapping size can stop at a certain value (e.g., 23, but it could be smaller).

TABLE 1
The list of optimal overlapping window size for each type of attack

| Type of attack | Optimum overlapping size range |
|---|---|
| DDoS | 5 to 23 |
| Patator | 7 to 23 |
| DoS | 19 to 23 |
| HeartBleed | 7 to 23 |

If the network traffic classification module (NTIDCM) classifies the input network traffic as “unknown” and the corresponding optimum overlapping window size range doesn't exist in the overlapping window size library (table 1), the maximum size of overlapping window size is applied to optimize the accuracy of the next result from the classification module. These results can be saved into system storage for future detection and the library can be updated.

Further experiments were conducted on the multi-classes' classification including Benign, DoS, and unknown attacks, using the UNSW-NB15 dataset. In that experiment, the training was run for 50 epochs.

The results have been compared with the results obtained with the system without the improvement.

Based on the structure of the NIDS using the feedback from the network attack prediction, the sampling interval chosen was three seconds. This sampling interval can be replaced with an overlapping window if the system detects that the image contains an anomaly signal.

Different optimization ranges of overlapping window size were applied, which were compatible with each type of attack described previously. With DoS attack, the overlapping size changed from 0 to 20. With other types of attack, categorized as “unknown”, the system determines the overlapping size and may resize the overlapping window to 23.

The previous model, without the improvement used an overlapping window size of 12.

The testing dataset was extracted during one working day from server IP “149.171.126.12” with 4815 requests.

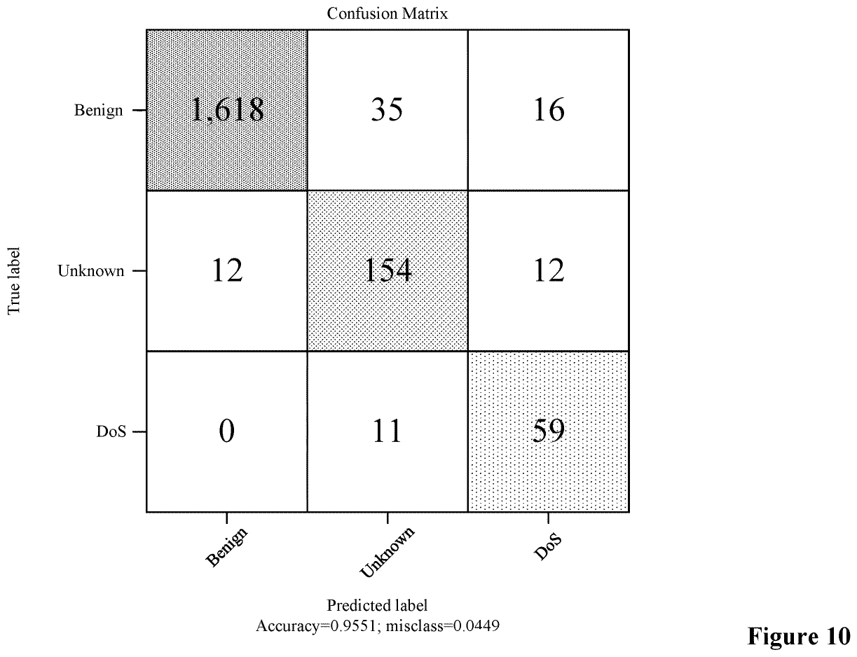

FIG. 10 shows the confusion matrix of the previous model, without the improvement, in inference mode.

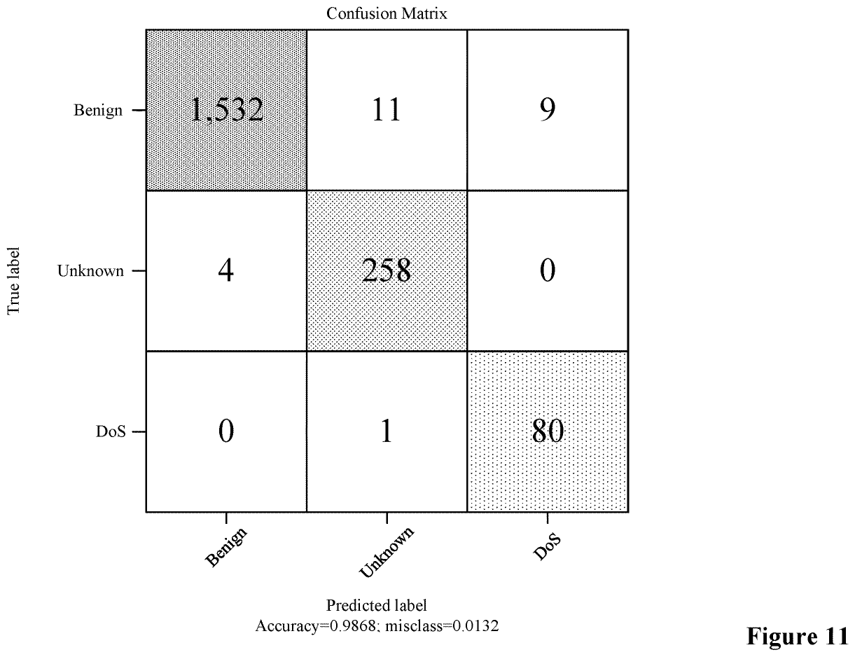

FIG. 11 shows the confusion matrix of the model using the feedback from the network attack prediction in inference mode.

Table 2 shows the comparison of F1-score, accuracy, and processing time on the 4815 requests between the previous model and the improved model.

TABLE 2
The comparison between the previous model and the improved model using
the feedback from the network attack prediction in inference mode

| | | | | | Time |
|---|---|---|---|---|---|
| | F1-Score | | | | Processing |
| | Benign | Unknown | DoS | Accuracy | (second) |
| Previous Model | 98.09% | 81.48% | 75.15% | 95.51% | 38.2 |
| Improved model using | 99.22% | 96.99% | 94.12% | 98.68% | 35.8 |
| Feedback | | | | | |

The improved model provides improved accuracy over the previous model and increases the processing speed of the whole system.

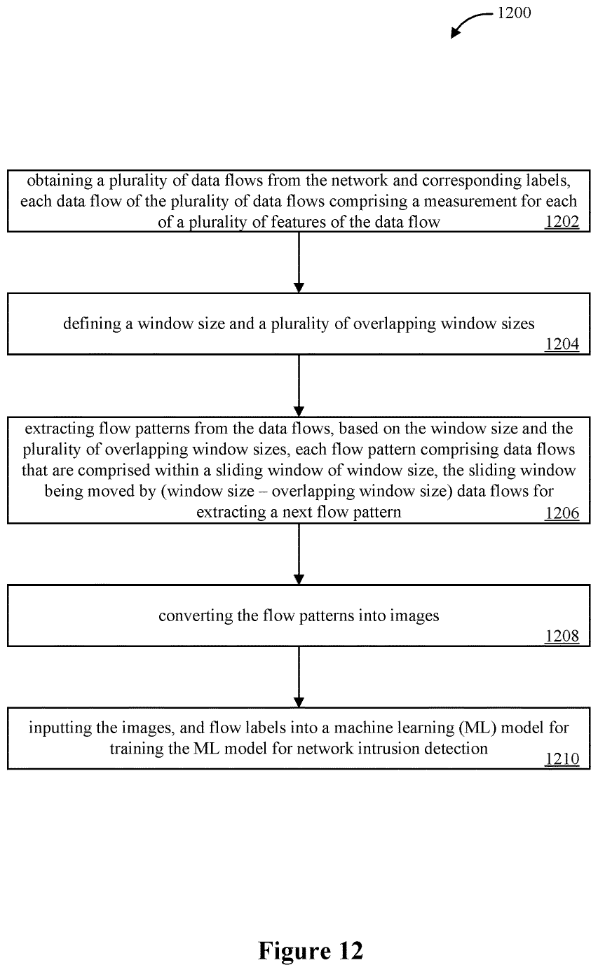

Turning to FIG. 12, there is provided a method 1200 for training a network intrusion detection system (NIDS) for detecting an intrusion in a network. The method comprises obtaining, step 1202, a plurality of data flows from the network and corresponding labels, each data flow of the plurality of data flows comprising a measurement for each of a plurality of features of the data flow. The method comprises defining, step 1204, a window size and a plurality of overlapping window sizes. The method comprises extracting, step 1206, flow patterns from the data flows, based on the window size and the plurality of overlapping window sizes, each flow pattern comprising data flows that are comprised within a sliding window of window size, the sliding window being moved by (window size—overlapping window size) data flows for extracting a next flow pattern. The method comprises converting, step 1208, the flow patterns into images. The method comprises inputting the images, step 1210, and flow labels into a machine learning (ML) model for training the ML model for network intrusion detection.

Flow patterns refer to blocks of data containing a plurality of consecutive data flows.

The method may further comprise, before the extracting step, identifying important features of the data flows and processing the plurality of data flows to keep only measurements corresponding to the identified important features.

Identifying the important features of the data flows may comprise applying a decision tree classification algorithm to identify the important features of the data flows, based on the Mahalanobis Distance-based Oversampling (MDO) technique.

Defining the window size may comprise defining a window size having a length, in rows, equal to a number of the identified important features.

Defining the plurality of overlapping window sizes may comprise defining overlapping window sizes comprised in an interval comprised between zero and the number of the identified important features minus one.

The labels may include benign, malicious and unknown.

The malicious label may be a category that further includes a Denial of Service (DoS) label, a Distributed DoS (DDoS) label, a Patator label and a Heartbleed label. A specific overlapping window may be defined, and associated with, each label.

The features may include any one or more of the following features: an internet protocol (IP) number of a source machine; an average size observed in a forward direction; an average number of bytes in a subflow in the forward direction; a port number of a destination machine; an average size of packet; a port number of the source machine; a minimum size of packet in a backward direction; a minimum time a flow was idle before becoming inactive; an average size of packet in the forward direction; a count number of push (PSH) transmission control protocol (TCP) flag; a flow duration; a total number of bytes used for headers in the forward direction; a maximum time between two packets sent in the forward direction; a standard deviation time between two packets sent in the forward direction; a maximum time a flow was idle before becoming active; a number of bytes sent in an initial backward window; a minimum segment size observed in the forward direction; a minimum time between two packets sent in the forward direction; a mean time a flow was active before becoming idle; a maximum time a flow was active before becoming idle; a number of packets with at least one byte of TCP data payload in the forward direction; a mean size of packet in the backward direction; a number of forward packets per second; and a mean length of a flow.

Converting the flow patterns into images may comprise finding a highest measurement value and a lowest measurement value for each feature in the data flows and using the highest measurement value and the lowest measurement value for mapping the measurement for each feature of each flow linearly to a 24-bit red, green, blue (RGB) range of 0000000 to 0xFFFFFF.

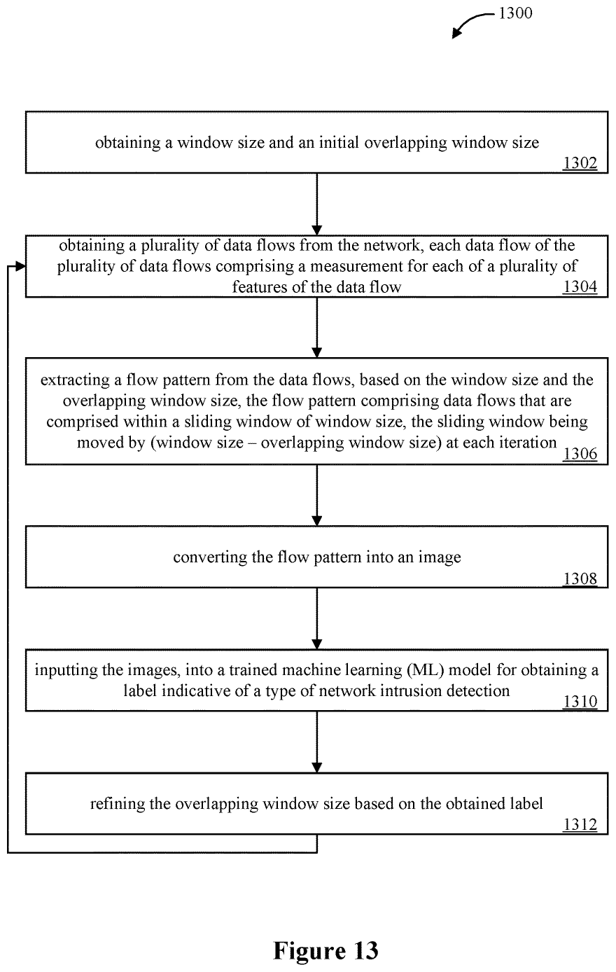

Turning to FIG. 13, there is provided a method 1300, for detecting an intrusion in a network, using a network intrusion detection system (NIDS). The method comprises obtaining, step 1302, a window size and an initial overlapping window size. The following steps are executed iteratively. The method comprises obtaining, step 1304, a plurality of data flows from the network, each data flow of the plurality of data flows comprising a measurement for each of a plurality of features of the data flow. The method comprises extracting, 1306, a flow pattern from the data flows, based on the window size and the overlapping window size, the flow pattern comprising data flows that are comprised within a sliding window of window size, the sliding window being moved by (window size—overlapping window size) at each iteration. The method comprises converting, step 1308, the flow pattern into an image. The method comprises inputting the image, step 1310, into a trained machine learning (ML) model for obtaining a label indicative of a type of network intrusion detection. The method comprises, step 1312 refining the overlapping window size based on the obtained label.

The trained ML model may be obtained using the method 1200. The window size may be defined during the training of the ML model.

Refining the overlapping window size based on the obtained label may comprise selecting a new overlapping window size within overlapping window sizes defined during the training of the ML model.

The labels may include benign, malicious and unknown.

The malicious label may be a category that further includes a Denial of Service (DoS) label, a Distributed DoS (DDoS) label, a Patator label and a Heartbleed label.

The features may include any one or more of the following features: an internet protocol (IP) number of a source machine; an average size observed in a forward direction; an average number of bytes in a subflow in the forward direction; a port number of a destination machine; an average size of packet; a port number of the source machine; a minimum size of packet in a backward direction; a minimum time a flow was idle before becoming inactive; an average size of packet in the forward direction; a count number of push (PSH) transmission control protocol (TCP) flag; a flow duration; a total number of bytes used for headers in the forward direction; a maximum time between two packets sent in the forward direction; a standard deviation time between two packets sent in the forward direction; a maximum time a flow was idle before becoming active; a number of bytes sent in an initial backward window; a minimum segment size observed in the forward direction; a minimum time between two packets sent in the forward direction; a mean time a flow was active before becoming idle; a maximum time a flow was active before becoming idle; a number of packets with at least one byte of TCP data payload in the forward direction; a mean size of packet in the backward direction; a number of forward packets per second; and a mean length of a flow.

Converting the flow patterns into images may comprise obtaining a highest measurement value and a lowest measurement value for each feature in the data flows and using the highest measurement value and the lowest measurement value for mapping the measurement for each feature of each flow linearly to a 24-bit red, green, blue (RGB) range of 0000000 to 0xFFFFFF.

It should be noted that methods and steps described herein are, generally, computer implemented methods and steps. The term computer may be interpreted as having different meanings, such as explained next, for example.

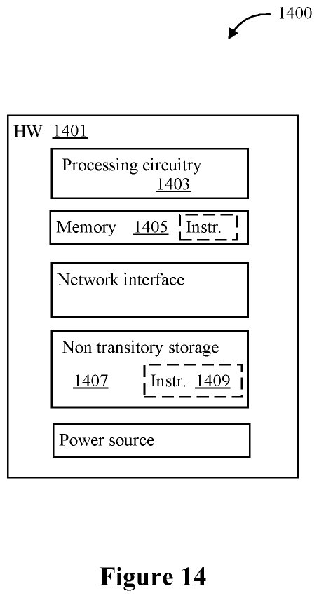

Referring to FIG. 14, there is provided a network intrusion detection system (NIDS) (HW) 1401, in which functions and steps described herein can be implemented.

The NIDS 1401 may be a server, network node, radio base station, or other computing device which may be part of a cloud computing system, edge computing system, or which may be a standalone device.

The server, network node, or other computing device may be configured to execute the methods described herein for training and using the ML model for detecting an intrusion in a network. Once an intrusion is detected, the network can take actions, known to a person skilled in the art, to remedy the problem.

The NIDS 1401 comprises processing circuitry 1403 and memory 1405. The memory 1405 can contain instructions executable by the processing circuitry 1403 whereby functions and steps described herein may be executed to provide any of the relevant features and benefits disclosed herein.

The NIDS 1401 may also include non-transitory, persistent, machine-readable storage media 1407 having stored therein software and/or instruction 1409 executable by the processing circuitry 1403 to execute functions and steps described herein. The NIDS may also include network interface(s) and a power source.

The instructions 1409 may include a computer program for configuring the processing circuitry 1403. The computer program may be stored in a physical memory local to the device, which can be removable, or it could alternatively, or in part, be stored in the cloud. The computer program may also be embodied in a carrier such as an electronic signal, optical signal, radio signal, or computer readable storage medium.

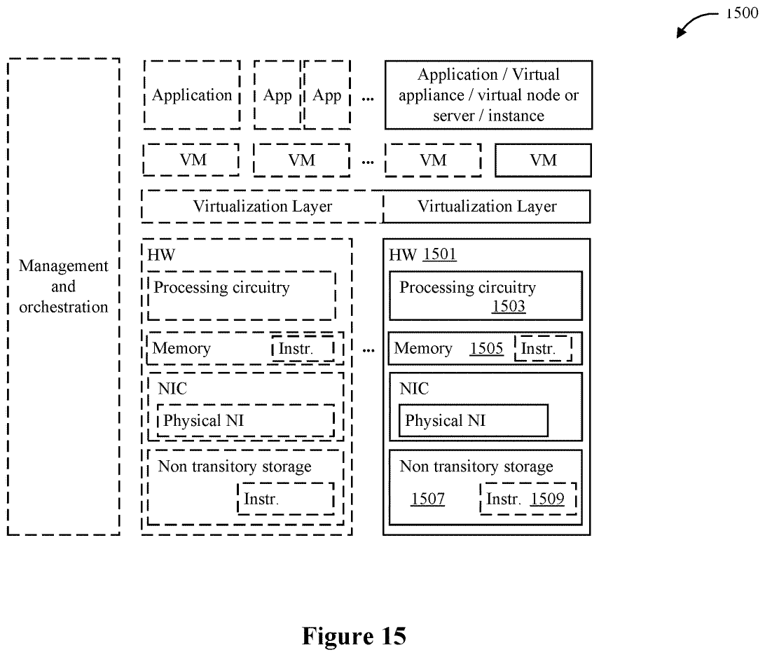

Referring to FIG. 15, there is provided a virtualization environment 1500 in which functions and steps described herein can be implemented.

The virtualization environment 1500 (which may go beyond what is illustrated in FIG. 15), may comprise systems, networks, servers, nodes, devices, etc., that are in communication with each other either through wire or wirelessly, e.g., through a network interface component (NIC) comprising physical network interface(s). Some or all of the functions and steps described herein may be implemented as one or more virtual components (e.g., via one or more applications, components, functions, virtual machines, containers, etc.) executing on one or more physical apparatus in one or more networks, systems, environment, etc.

A virtualization environment provides hardware 1501 comprising processing circuitry 1503 and memory 1505. The memory 1505 can contain instructions executable by the processing circuitry 1503 whereby functions and steps described herein may be executed to provide any of the relevant features and benefits disclosed herein.

The hardware 1501 may also include non-transitory, persistent, machine-readable storage media 1507 having stored therein software and/or instruction 1509 executable by the processing circuitry 1503 to execute functions and steps described herein.

The instructions 1509 may include a computer program for configuring the processing circuitry 1503. The computer program may be stored in a removable memory, such as a portable compact disc, portable digital video disc, or other removable media. The computer program may be stored in a physical memory local to the hardware 1501, which can be removable, or it could alternatively, or in part, be stored in the cloud. The computer program may also be embodied in a carrier such as an electronic signal, optical signal, radio signal, or computer readable storage medium.

Referring again to FIGS. 14 and 15, there is provided a network intrusion detection system (NIDS) 1401, 1502 comprising processing circuitry 1403, 1503 and a memory 1405, 1505, the memory containing instructions executable by the processing circuitry whereby the NIDS is operative to execute the steps of the method 1200, the steps of the method 1300 and/or any other step or combination of steps described herein.

Still referring to FIGS. 14 and 15, there is provided a non-transitory computer readable media 1407, 1507 having stored thereon instructions 1409, 1509 for executing a method in a network intrusion detection system (NIDS), the instructions comprising the steps of the method 1200, the steps of the method 1300 and/or any other step or combination of steps described herein.

Modifications will come to mind to one skilled in the art having the benefit of the teachings presented in the foregoing description and the associated drawings. Therefore, it is to be understood that modifications, such as specific forms other than those described above, are intended to be included within the scope of this disclosure. The previous description is merely illustrative and should not be considered restrictive in any way. The scope sought is given by the appended claims, rather than the preceding description, and all variations and equivalents that fall within the range of the claims are intended to be embraced therein. Although specific terms may be employed herein, they are used in a generic and descriptive sense only and not for purposes of limitation.

1. A computer implemented method, for training a network intrusion detection system (NIDS) for detecting an intrusion in a network, comprising:
obtaining a plurality of data flows from the network and corresponding labels, each data flow of the plurality of data flows comprising a measurement for each of a plurality of features of the data flow;
defining a window size and a plurality of overlapping window sizes;
extracting flow patterns from the data flows, based on the window size and the plurality of overlapping window sizes, each flow pattern comprising data flows that are comprised within a sliding window of window size, the sliding window being moved by (window size-overlapping window size) data flows for extracting a next flow pattern;
converting the flow patterns into images; and
inputting the images, and flow labels into a machine learning (ML) model for training the ML model for network intrusion detection.

2. The method of claim 1, further comprising, before the extracting step:
identifying important features of the data flows; and
processing the plurality of data flows to keep only measurements corresponding to the identified important features.

3. The method of claim 2, wherein identifying the important features of the data flows comprises applying a decision tree classification algorithm to identify the important features of the data flows, based on the Mahalanobis Distance-based Oversampling (MDO) technique.

4. The method of claim 2, wherein defining the window size comprises defining a window size having a length, in rows, equal to a number of the identified important features.

5. The method of claim 4, wherein defining the plurality of overlapping window sizes comprises defining overlapping window sizes comprised in an interval comprised between zero and the number of the identified important features minus one.

6. The method of claim 1, wherein the labels include: benign, malicious and unknown.

7. The method of claim 6, wherein the malicious label is a category that further includes a Denial of Service (DoS) label, a Distributed DoS (DDoS) label, a Patator label and a Heartbleed label.

8. (canceled)

9. The method of claim 1, wherein the features include any one or more of the following features:
an internet protocol (IP) number of a source machine;
an average size observed in a forward direction;
an average number of bytes in a subflow in the forward direction;
a port number of a destination machine;
an average size of packet;
a port number of the source machine;
a minimum size of packet in a backward direction;
a minimum time a flow was idle before becoming inactive;
an average size of packet in the forward direction;
a count number of push (PSH) transmission control protocol (TCP) flag;
a flow duration;
a total number of bytes used for headers in the forward direction;
a maximum time between two packets sent in the forward direction;
a standard deviation time between two packets sent in the forward direction;
a maximum time a flow was idle before becoming active;
a number of bytes sent in an initial backward window;
a minimum segment size observed in the forward direction;
a minimum time between two packets sent in the forward direction;
a mean time a flow was active before becoming idle;
a maximum time a flow was active before becoming idle;
a number of packets with at least one byte of TCP data payload in the forward direction;
a mean size of packet in the backward direction;
a number of forward packets per second; and
a mean length of a flow.

10. The method of claim 1, wherein converting the flow patterns into images comprises:
finding a highest measurement value and a lowest measurement value for each feature in the data flows; and
using the highest measurement value and the lowest measurement value for mapping the measurement for each feature of each flow linearly to a 24-bit red, green, blue (RGB) range of 0000000 to 0xFFFFFF.

11. A computer implemented method, for detecting an intrusion in a network, using a network intrusion detection system (NIDS), comprising:
obtaining a window size and an initial overlapping window size;
iteratively:
obtaining a plurality of data flows from the network, each data flow of the plurality of data flows comprising a measurement for each of a plurality of features of the data flow;
extracting a flow pattern from the data flows, based on the window size and the overlapping window size, the flow pattern comprising data flows that are comprised within a sliding window of window size, the sliding window being moved by (window size—overlapping window size) at each iteration;
converting the flow pattern into an image;
inputting the image, into a trained machine learning (ML) model for obtaining a label indicative of a type of network intrusion detection; and
refining the overlapping window size based on the obtained label.

12. The method of claim 11, wherein the trained ML model is obtained using the method of claim 1.

13. The method of claim 11, wherein the window size is defined during the training of the ML model.

14. The method of claim 11, wherein refining the overlapping window size based on the obtained label comprises selecting a new overlapping window size within overlapping window sizes defined during the training of the ML model.

15. The method of claim 11, wherein the labels include: benign, malicious and unknown.

16. The method of claim 15, wherein the malicious label is a category that further includes a Denial of Service (DoS) label, a Distributed DoS (DDoS) label, a Patator label and a Heartbleed label.

17. The method of claim 11, wherein the features include any one or more of the following features:
an internet protocol (IP) number of a source machine;
an average size observed in a forward direction;
an average number of bytes in a subflow in the forward direction;
a port number of a destination machine;
an average size of packet;
a port number of the source machine;
a minimum size of packet in a backward direction;
a minimum time a flow was idle before becoming inactive;
an average size of packet in the forward direction;
a count number of push (PSH) transmission control protocol (TCP) flag;
a flow duration;
a total number of bytes used for headers in the forward direction;
a maximum time between two packets sent in the forward direction;
a standard deviation time between two packets sent in the forward direction;
a maximum time a flow was idle before becoming active;
a number of bytes sent in an initial backward window;
a minimum segment size observed in the forward direction;
a minimum time between two packets sent in the forward direction;
a mean time a flow was active before becoming idle;
a maximum time a flow was active before becoming idle;
a number of packets with at least one byte of TCP data payload in the forward direction;
a mean size of packet in the backward direction;
a number of forward packets per second; and
a mean length of a flow.

18. The method of claim 11, wherein converting the flow patterns into images comprises:
obtaining a highest measurement value and a lowest measurement value for each feature in the data flows; and
using the highest measurement value and the lowest measurement value for mapping the measurement for each feature of each flow linearly to a 24-bit red, green, blue (RGB) range of 0000000 to 0xFFFFFF.

19. A network intrusion detection system (NIDS) comprising processing circuitry and a memory, the memory containing instructions executable by the processing circuitry whereby the NIDS is operative to execute the steps of claim 1.

20. A non-transitory computer readable media having stored thereon instructions for executing a method in a network intrusion detection system (NIDS), the instructions comprising the steps of claim 1.
